(19) United States
(12) Patent Application Publication
(10) Pub. No.: US 2010/0227574 A1
(43) Pub. Date: Sep. 9, 2010

(54) INTEGRATED CIRACUIT WITH RF MODULE, ELECTRONIC DEVICE HAVING SUCH AN IC AND METHOD FOR TESTING SUCH A MODULE

(76) Inventors: Jeroen Kuenen, Beuningen (NL); Saleem Kala, Herouville Saint-Clair (FR); Philippe Soleil, Amaye Sur Orne (FR); Bilal El Kassir, Tripoli (LB); Christophe Kelma, Bayeux (FR)

Correspondence Address: NXP, B.V.;NXP INTELLECTUAL PROPERTY & LICENSING, M/S41-SJ, 1109 MCKAY DRIVE, SAN JOSE, CA, 95131, US

(21) Appl. No.: 12/733,220

(22) PCT Filed: Aug. 14, 2008
(86) PCT No.: PCT/IB2008/053271

§ 371 Date: Feb. 16, 2010

(30) Foreign Application Priority Data
Aug. 16, 2007 (EP) 07114475.2

(51) Int. Cl. H04B 17/00

(52) U.S. Cl. 455/115.2

(57) ABSTRACT

The present invention discloses an integrated circuit (200) including a module (130) for processing a radio-frequency (RF) signal during normal operation of the integrated circuit. The IC (200) has an on-chip test arrangement for generating an accurate RF test signal for testing the module (130) in a test mode. To this end, the test arrangement comprises a signal source (210) for generating a radio-frequency control signal in the test mode and a complementary transistor pair (230) arranged in series, said pair being coupled between a first supply rail and a second supply rail, and being arranged to generate the radio-frequency test signal on its output in response to the radio-frequency control signal supplied to its control terminals. The invention is based on the realization that if a stable enough supply voltage is provided to the transistor pair, the pair can be forced to produce an accurate rail-to-rail voltage swing at RF frequencies on its output. This output signal can be used to test the RF module (130) with high accuracy, thus obviating the need to use expensive external test equipment.

The present invention relates to an integrated circuit (IC) comprising a module for processing a radio-frequency (RF) signal during normal operation of the integrated circuit.

The present invention further relates to an electronic device comprising such an IC.

The present invention yet further relates to a method for testing a module of such an IC.

Nowadays, many ICs comprise RF signal processing functionality, such as ICs for integration in mobile communication devices, global positioning devices and so on. The testing of this functionality is not without problems. In particular, test cost is a serious issue because traditional test equipment is unsuitable for generating RF signals of sufficient quality. For this reason, testing of RF circuits is typically done using a dedicated RF tester, when an RF signal of sufficient quality and strength is needed. For instance, for all signal reception channels (RXs) and signal transmission channels (TXs), testing must be done at absolute accuracy levels since the specifications of these channels are typically defined using absolute levels. The use of dedicated RF testers means that the test costs are very high; these costs can become as high as the cost of the untested silicon.

Efforts have been made to reduce the test cost of RF modules of an IC by looking at self-test solutions. For instance, PCT patent application WO 2004/054141 discloses an IC having a RF transmission channel. Part of its output signal is branched off to a built-in transmission channel tester that down-converts the output signal and compares the down-converted low frequency signal with one or more reference signals, such as the extremes of the allowable power range of the output signal.

Other self-test arrangements, such as the arrangement disclosed in U.S. Pat. No. 7,017,087, provide a feedback loop from the transmission channel to the reception channel such that the reception channel can be tested with the RF signal generated by the transmission channel. However, the drawback of such arrangements is that the RF signal has to be generated from a low-frequency signal by the transmission channel, which means that any noise introduced in the signal up-conversion in the transmission channel will make it impossible to accurately test the receiver channel. In addition, the aforementioned prior art documents disclose the generation of a test signal for which it is very difficult to accurately know its signal strength. For instance, in WO2004/054141 the gain inaccuracy of the transmission channel makes it hard to accurately determine the signal level, as is the case in U.S. Pat. No. 7,017,087. Moreover, such arrangements cannot be used to test ICs that do not have transmission channels, such as ICs for processing global positioning satellite (GPS) signals.

The present invention seeks to provide an IC in which RF test signals can be generated without the need for a transmission channel.

The present invention also seeks to provide an electronic device comprising such an IC.

The present invention further seeks to provide a method for testing a RF signal processing module of such an IC.

According to a first aspect of the present invention, there is provided an IC comprising a module for processing a radio-frequency signal during normal operation of the integrated circuit and a test arrangement for generating a radio-frequency test signal for testing the module in a test mode, the test arrangement comprising: a signal source for generating a radio-frequency control signal in the test mode and a complementary transistor pair, the transistors of said pair being coupled in series between a first supply rail and a second supply rail, and being arranged to generate the radio-frequency test signal on its output in response to the radio-frequency control signal supplied to its control terminals.

The present invention is based on the realization that signal sources such as phase locked loops (PLLs) are capable of producing RF signals. Such signals are usually not suitable for use as RF test signals because of their shape and noise characteristics. However, ongoing advances in semiconductor processing technology now make it possible to manufacture transistors that can respond to such RF signals when used to control these transistors. To this end, a transistor pair is provided that is capable of responding to a RF control signal. The gates of the transistor pair are coupled to the RF signal source. By driving the transistor pair with a strong enough RF control signal, the transistor pair is forced to produce a rail-to-rail voltage swing at radio frequencies; in CMOS 065 technology, accurate RF test signals up to 6 GHz can be produced this way.

An attenuator may be provided between the transistor pair and the module to attenuate the RF test signal to an appropriate signal strength. To ensure that the RF control signal has sufficient signal strength, an amplifying stage may be provided between the signal source and the inverter.

In an advantageous embodiment, the integrated circuit further comprises a further signal source for generating a further radio-frequency control signal having a different frequency than the radio-frequency signal; a further complementary transistor pair, the transistors of said further pair being coupled in series between the first supply rail and the second supply rail, and being arranged to generate the further radio-frequency test signal on its output in response to the further radio-frequency control signal supplied to its control terminals; and a further attenuator coupled between the further transistor pair and the input of the module. The further signal source may be programmable to generate RF signals of different frequencies. This arrangement facilitates the determination of a third-order intercept point (IP3) of an amplifier in the module. Such an IP3 determination is an important indicator of the gain of such an amplifier, e.g. a LNA. Hence, the provision of a further attenuator facilitates the generation of the two signals, i.e. tones, of different frequency required for an IP3 determination.

These two tones may have different signal strengths. For this reason, the attenuator and further attenuator may attenuate the different tones by different attenuation factors.

Advantageously, the attenuator may be a programmable attenuator in order to attenuate signals with different signal strengths or to provide attenuated signals with different signal strengths. The latter is for instance advantageous if the module to be tested comprises a plurality of signal processing modes, which each mode requiring separate testing. A programmable attenuator facilitates time-efficient testing of these multiple modes.

The programmable attenuator may comprise a plurality of branches coupled in parallel between the transistor pair and the module, wherein each branch comprises a selection switch for selecting said branch in the test mode, and wherein the plurality of branches comprise a first branch comprising a first resistor coupled between the transistor pair and a first node and a second resistor coupled between a fixed potential source and the first node for providing a fixed attenuation factor; and at least one further branch comprising a first further resistor coupled between the transistor pair and a second node and a programmable resistor arrangement coupled between a fixed potential source and the second node for providing a programmable attenuation factor.

The programmable resistor arrangement may comprise a plurality of resistors coupled in parallel, each transistor of said plurality of transistors being coupled to a respective further enable switch. Hence, the attenuation factor of the attenuator may be programmed by programming the programmable resistor arrangement.

The attenuation factor of the at least one further branch may be further tuned by choosing an appropriate resistance ratio between the transistor in between the complementary transistor pair and the attenuator node on the one hand and the effective resistance of the programmable resistor arrangement at the other hand. To this end, the resistance of the transistor in between the complementary transistor pair and the attenuator node may have a predefined resistance. Alternatively, a further branch comprises a second further resistor coupled in parallel with the first further transistor. This lowers the effective resistance of the first stage of the programmable attenuator.

In an advantageous embodiment, the programmable attenuator comprises a first further branch having a single further resistor coupled between the transistor pair and the second node of said branch, and a second further branch having a first further resistor coupled in parallel with a second further resistor between the transistor pair and the second node of said branch. This is for instance particularly advantageous in case of a significant spread in the signal strengths of the various operational modes of the module to be tested, because the first further branch is particularly suitable for producing a low-noise signal with a relatively large signal strength, whereas the second further branch is particularly suitable for producing a low-noise signal with a relatively small signal strength.

In an embodiment, the resistor in the first stage of the various branches of the programmable attenuator, i.e. the transistor coupled between the complementary transistor pair and one of said nodes is coupled to the transistor pair via a further node, the further node being coupled to a fixed potential source via an enable switch. This facilitates the clamping of the branches to the fixed potential source, e.g. ground, when the branches are bypassed either in the test mode or during functional mode of the integrated circuit, to avoid a floating potential on these paths, which may negatively affect the accuracy of the attenuation of the test signal by the enabled branch.

The various selection and enable switches may be controlled in any suitable way, e.g. by an embedded state machine that steps through a predetermined test sequence in response to a test enable signal.

Preferably, the test arrangement further comprises a shift register arranged to provide test configuration data for configuring the respective selection switches, the respective enable switches and/or the respective programmable resistors. This allows for a flexible test arrangement where tests may be configured by shifting the appropriate configuration data into the shift register. The shift register may be a boundary scan compliant shift register and may form part of a JTAG test access port.

As will be appreciated by the skilled person, the characteristics of the enable switches in the at least one further branch of the programmable attenuator may be dependent of process variations, which makes it difficult to control the accuracy of attenuation factor of this branch.

For this reason, the integrated circuit may further comprise a signal processor coupled to the module, the signal processor being arranged to select the first branch; perform a first gain measurement; select one of the at least one further branch; program the programmable resistor of selected further branch such that the selected further branch is intended to have the same attenuation factor as the first branch; perform a second gain measurement; calculate a correction factor from a difference between the first gain measurement and the second gain measurement; and correct a subsequent gain measurement using the selected further branch with the correction factor. This ensures that the process variations of the enable and selection switches are compensated for. The signal processor may be arranged to repeat these steps for each further branch of the programmable attenuator such that each branch has its own correction factor.

At this point, it is noted that the accuracy of the RF signal produced by the inverter depends on the quality, i.e. stability, of the supply voltage that is supplied to the IC during the test mode. However, as will be apparent to the skilled person, high-quality supply voltages can be routinely produced, for instance by standard test equipment.

According to a further aspect of the present invention, there is provided an electronic device comprising the IC of the present invention. Such an electronic device, such as a mobile phone, a GPS receiver, a laptop having a built-in RF transceiver and so on, benefits from the reduction in test cost of the IC of the present invention, and can therefore be marketed at a more competitive price.

It should be noted that the IC of the present invention may be used as an accurate RF test signal source for testing off-chip components, in which case the RF signal processing module may be omitted.

According to yet a further aspect of the present invention, there is provided a method for testing a module of an IC integrated circuit, the module being arranged to process a radio-frequency signal during normal operation of the integrated circuit, the method comprising providing the integrated circuit with a test arrangement for generating a radio-frequency test signal for testing the module in a test mode, the test arrangement comprising a signal source for generating a radio-frequency control signal in the test mode; a complementary transistor pair arranged in series, said pair being coupled between a first supply rail and a second supply rail, and being arranged to generate the radio-frequency test signal on its output in response to the radio-frequency control signal supplied to its control terminals; generating a radio-frequency control signal with the signal source; and providing the first supply rail with a stable supply voltage such that the transistor pair produces the radio-frequency test signal within acceptable noise levels in response to the radio-frequency control signal.

This method allows for the generation of a high-quality RF test signal without requiring the presence of a transmission channel for this purpose.

In an embodiment, the test arrangement further comprises an attenuator coupled, in the test mode, between the output of the transistor pair and an input of the module, the attenuator comprising a plurality of branches coupled in parallel between the transistor pair and the module, wherein each branch comprises a selection switch for selecting said branch in the test mode, and wherein the plurality of branches comprise a first branch comprising a first resistor coupled between the transistor pair and a first node and a second resistor coupled between a fixed potential source and the first node for providing a fixed attenuation factor; and at least one further branch comprising a first further resistor coupled between the transistor pair and a second node and a programmable resistor coupled between a fixed potential source and the second node for providing a programmable attenuation factor; wherein the method further comprises selecting the first branch; performing a first gain measurement; selecting one the at least one further branch; programming the programmable resistor of selected further branch such that the selected further branch is intended to have the same attenuation factor as the first branch; performing a second gain measurement; calculating a correction factor from a difference between the first gain measurement and the second gain measurement; and correcting a subsequent gain measurement using the selected further branch with the correction factor. This ensures that the gain of the amplifier stages of the module, e.g. of the LNA, can be determined accurately because any process variations in the switches present in the programmable attenuator are compensated for.

The invention is described in more detail and by way of non-limiting examples with reference to the accompanying drawings, wherein:

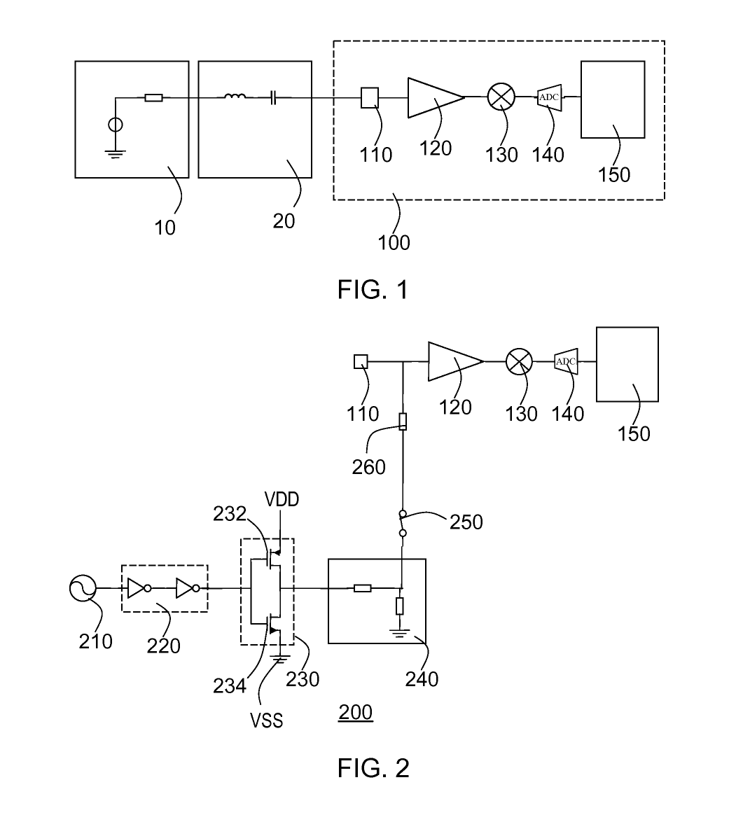

FIG. 1 depicts a prior art test arrangement; and

FIG. 2 depicts an embodiment of the IC of the present invention.

It should be understood that the Figures are merely schematic and are not drawn to scale. It should also be understood that the same reference numerals are used throughout the Figures to indicate the same or similar parts.

FIG. 1 shows a prior art test arrangement for testing an IC 100. The IC 100 has an input pad 110, a low-noise amplifier (LNA) 120, a RF signal processing module 130, an analog-to digital converter (ADC) 140 and a signal evaluator 150. The input pad 110 is coupled to an external RF signal producing tester 10 via a matching network 20. The matching network matches the output impedance of the tester 10 to the input impedance of the LNA 120. The signal from tester 10 is typically injected into the pad 110 via a RF probe (not shown). The ADC 140 converts the down-converted analog output signal of the module 130 into a digital signal, which is processed by the signal evaluator 150. The signal evaluator 150 may for instance measure the gain of the module 130, or any other relevant signal characteristic.

There are several drawbacks to this setup. For instance, an expensive tester 10 is required to produce the RF test signal. A matching network 20 has to be added to the load board (the holder to which the IC 100 is fitted to undergo its test), and a probe contact is required to feed the RF test signal to the pad 110; such a contact may give rise to unpredictable behavior, for instance due to the presence of dust particles between the probe and pad.

These drawbacks are overcome by the present invention. FIG. 2 shows an embodiment of an IC 200 according to the present invention. In comparison to IC 100, the IC 200 is extended with a built-in RF test signal generating arrangement. A signal source 210, e.g. a phase locked loop (PLL) is provided for generating a control signal at radio frequencies in a test mode of the IC 200. Alternatives to a PLL may also be used. The output of the signal source 210 may be amplified by an optional amplifying stage 220. The amplifying stage 220 may be implemented in any known way. An inverter chain is an advantageous implementation because of its limited area overhead.

The test arrangement further comprises a complementary transistor pair 230 coupled in series between a first supply rail VDD and a second supply rail VSS, and having their control terminals coupled to the output of the signal source 210. In the context of the present invention, the phrase ‘complementary’ is used to indicate that the first transistor 232 pulls the output of the transistor pair 230 to the voltage of the first supply rail VDD in response to a first value of the RF control signal while the second transistor 234 pulls the output of the transistor pair 230 to the voltage of the second supply rail VDD in response to a value of the RF control signal that is complementary to the first value of this control signal. In short, the first transistor 232 and the second transistor 234 are responsive to complementary RF control signal values. Examples of such a complementary transistor pair 230 include an inverter and an inverting buffer. For example, the first transistor 232 and the second transistor 234 may be an n-type and a p-type transistor respectively, in which case the transistors may share the same control input.

When testing the module 130 of the IC 200 in accordance with the method of the present invention, the supply rails VDD and VSS are coupled to a voltage supply that is capable of generating a high-quality, i.e. stable, supply voltage. The IC 200 is switched to a test mode in which the signal source 210 is activated. The RF control signal is generated by the signal source 210 and fed to the control terminals of the transistor pair 230. The control signal has to be of sufficient strength to ensure that the transistor pair 230 is driven hard enough for the transistor pair 230 to reach a rail-to-rail voltage swing on its output, thus producing an RF test signal having high absolute accuracy. It is important that a high-quality supply voltage is provided, because any fluctuations in the supply voltage will be reproduced on the output of the transistor pair 230 due to the rail-to-rail nature of its output behavior, and would thus lead to a deterioration of the RF test signal produced on the output of the transistor pair 230. In case the signal source 210 is incapable of producing a RF control signal of sufficient strength, the optional amplifying stage 220 should be included in the test arrangement.

The quality of the RF test signal may be further improved by feeding it through an attenuator 240. The attenuator 240 comprises two well-matched resistors to get an accurate attenuation of the RF test signal. The attenuated RF test signal is provided to the LNA 120 via switch 250 and a resistor 260. The switch 250 is used to make the RF test signal available to the RF signal processing module 130 in the test mode. The resistor 260 is introduced to the RF test signal path to avoid degradation of the noise figure of the LNA 120 during normal operation of the IC 200.

In order to be able to accurately test the RF signal processing module 130, it is important that the signal strength of the RF test signal provided to the input of LNA 120 is well-defined. The signal strength level typically depends on the actual resistance of the resistor 260 and the input impedance of LNA 120. To this end, a dummy version (not shown) of the resistor 260 may be provided on which a measurement is performed to determine its resistance. Because the dummy and actual resistor 260 are made using the same process steps, the deviation of the dummy resistance from its intended value can be used to compensate for any variance in the resistance of resistor 260, because resistor 260 typically exhibits a substantially similar deviation from its intended resistance value.

Deviations from the intended resistance of resistor 260 will cause deviations from the intended input impedance of the LNA 120. Because the source impedance of the LNA 120 is higher compared to the setup shown in FIG. 1, these deviations will be more pronounced than in the setup of FIG. 1, which can introduce errors in the evaluation result of the output signal produced by module 130. For this reason, Monte Carlo (MC) simulations have been performed on a realistic LNA model. The MC simulations have shown that the error is limited to plus or minus 1 dB when measuring the gain of the LNA 120, which is comparable to the accuracy achieved when using an external tester 10.

However, the error can be reduced by compensating for these deviations. The measurement of the dummy resistance may be used to compensate the signal measured by the signal evaluator 150. In addition, the input impedance of the LNA 120 may be measured prior to testing the module 130, and the measured impedance may be used in the evaluation of the signal that the module 130 produces in response to the RF test signal. It has been demonstrated that compensation of the aforementioned deviations can reduce the error in the test result of the module 130 to as little as 0.25 dB, which is a better accuracy than achieved with the external tester 10.

The IC 200 may comprise a central processing unit (not shown) that is arranged to enable the various components upon the IC 200 entering the test mode. The CPU may further be configured to perform the calibration measurements of the dummy transistor and the LNA 120, and may be configured to implement the signal evaluator 150.

It will be appreciated that various elements of the IC 200 such as the amplifying stage, i.e. LNA 120, in front of the RF signal processing module 130, and the ADC 140 behind the module 130 are shown by way of a non-limiting example only. Other known arrangements for processing a RF signal are equally feasible. It is unnecessary to show many different RF signal processing arrangements because they do not require significant modifications to the inventive concept of the present invention, i.e. the on-chip RF test signal generation arrangement.

At this point, attention is drawn to the fact that the present invention is not limited to the test arrangement shown in FIG. 2. In an alternative embodiment, the test arrangement of the present invention is arranged to perform an IP3 measurement of an RF IC receiver stage, and in particular the LNA 120 thereof. Such measurements are suitable for determining the non-linearity of a gain device such as a LNA. In an IP3 measurement, a gain component such as the LNA 120 is subjected to two sinusoidal signals f₁ and f₂ of identical amplitude but different frequency. These signals are sometimes also referred to as tones. As will be demonstrated in the brief theoretical description of IP3 measurements, it is of crucial importance that the power of these tones is well-defined to ensure that an accurate estimate of the non-linearity of the device under test (DUT) is obtained.

The response of the DUT can be approximated by means of a Taylor expansion in which the IP3 point relates to the non-linear products of the tones caused by the third-order term of the expansion s(t)=G·f(t)+D·f³(t) wherein f(t) is the sinusoidal input signal, G is the gain of the DUT and D is the third-order component. When injecting two tones f₁, f₂ into the DUT, the resulting output tones are f₂ coming from G·f(t) and 2f₁−f₂ and 2f₂−f₁ coming from D·f³(t). For signals f1, f2 having an input power Pin, the IP3 can be written as:

$$IP 3 = {P}_{in} + \frac{Δ P}{3 - 1} \qquad ( 1 )$$

This equation demonstrates that the accuracy of the IP3 measurement is directly dependent of the accuracy of the input power Pin. Hence, this output itself must be well-defined, i.e. exhibit sufficiently small noise margins. In RF production testing, the accuracy of the input power Pᵢₙ should be better than 1 dB, and preferably be better than 0.5 dB. Such accuracy cannot be achieved with the prior art on-chip test arrangements using a loopback path from a transmitter stage to a receiver stage because the output level of the signal generated by the transmitter stage is typically not well-defined enough to ensure an accurate determination of the IP3.

However, this problem can be overcome by the present invention because the RF test signal arrangement of the present invention can provide RF test signals that have a well-defined power level as long as a high-quality, i.e. stable, voltage is supplied on the power rails of the IC of the present invention.

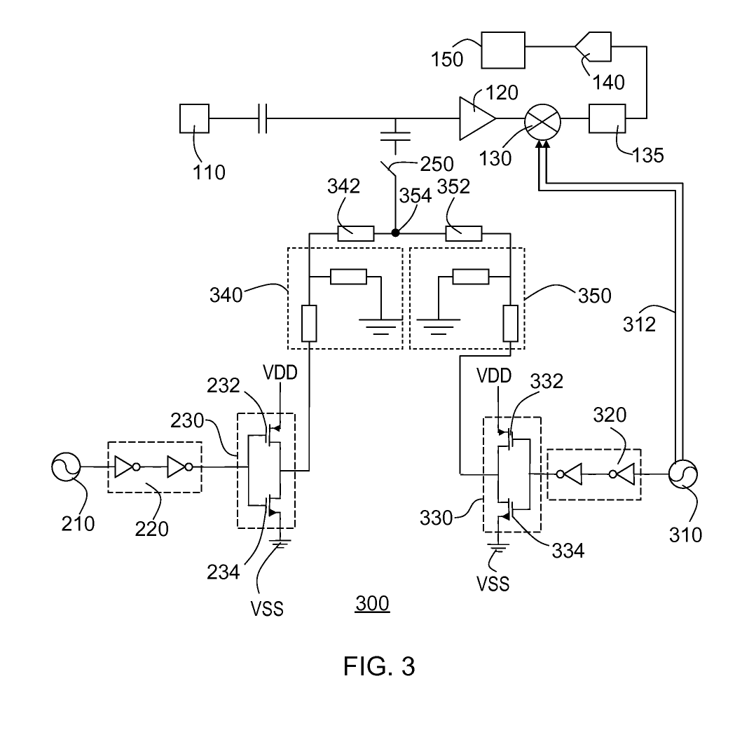

An example embodiment of such an IP3 measurement arrangement in accordance with the present invention is shown in FIG. 3. In addition to the signal source 210 and complementary transistors 230, the IC 300 comprises a further signal source 310 coupled to the control terminals of the transistors 332 and 334 of a further complementary transistor pair 330. The further signal source 310 may be dedicated to the generation of a test signal or may be the RF signal source used in the operational mode of the IC 300. The latter is preferable because such a signal source is typically capable of generating signals with different frequencies, which makes it possible to perform different IP3 measurements using the frequency range of the signal source 310. The further signal source 310 may be coupled to the further complementary transistor pair 330 via an optional further amplifying stage 320, as explained in the detailed description of FIG. 2.

The test arrangement further comprises a first attenuator 340 coupled between the output stage of the complementary transistor pair 230 and the input of the LNA 120 and a second attenuator 350 coupled between the output stage of the further complementary transistor pair 330 and the input of the LNA 120. In other words, the first attenuator 340 and the second attenuator 350 share the input of the LNA 120 via the test mode enabling switch 250, which may be coupled to the LNA 120 via an AC coupling capacitance to further stabilize the signals provided by the attenuator pair. The attenuation of the test signals is necessary to ensure that the signals do not saturate the receiver chain, which would introduce inaccuracies in the IP3 measurement.

The first attenuator 340 and the second attenuator 350 each comprise a resistor pair for providing the required attenuation of the RF test signals generated by the signal source 210 and the further signal source 310. An implementation using a pair of resistors has the advantage that the attenuators can be realized in CMOS technology whilst still exhibiting a spread of less than 0.2 dB in their attenuation factors as caused by process variation and mismatch. The resistances of these resistors may have any suitable value to achieve the required attenuation. This is a routine design exercise for the skilled person and this will not be further explained for reasons of brevity only. It should however be understood that the power level of the signal attenuated by the first attenuator 340 should be identical to the power level of the signal attenuated by the second attenuator 350. In a preferred embodiment, the resistors in both the first attenuator 340 and the second attenuator 350 have the same resistance.

Consequently, the respective input signals of these attenuators also must have the same power level. This may be achieved by matching the dimensions of the transistors 232 and 234 to the dimensions of the further transistors 332 and 334, such that the complementary transistor pairs 230, 330 generate the same power levels. It will be appreciated that the signal source 210 and the further signal source 310 may produce signals at different power levels due to the fact that the complementary transistor pairs 230, 330 are driven in saturation, i.e. driven in full swing between VDD and VSS, such that any excess input signal power will be dissipated without leading to an increase in output signal power.

The output of the first attenuator 340 is coupled to the node 354 via a first bridging resistor 342 and the output of the second attenuator 350 is coupled to the node 354 via a first bridging resistor 352. These bridging resistors ensure the accurate generation of the two-tone signal for testing the LNA 120 by combination of the signals attenuated by the first attenuator 340 and the second attenuator 350.

At the node 354, the power level of this two-tone signal may be defined as P_{vdd}/A, wherein Pvdd is the power level generated by the complementary transistor pairs 230 and 330, and A is the attenuation factor of the attenuators 340 and 350. The test enable switch 250 and the AC coupling capacitance provide a further attenuation B of the two tones, such that the power level of the test signal at the input of the LNA 120 may be described by P_{vdd}/(A*B). It has been demonstrated by simulation that this power level can be generated to be stable within a 0.5 dB range within the 6σ standard deviation in process spread and mismatch of the parameters and dimensions of the various CMOS components in the test arrangement of FIG. 3.

The further signal source may provide one or more reference signals 312 to the RF signal processing module 130, e.g. a quadrature mixer. The module 130 may be coupled to the ADC 140 via a filter 135. The ADC 140 may be coupled to a signal processor 150 for processing the signals generated by the module 130 and for calculating the IP3 from the processed signals.

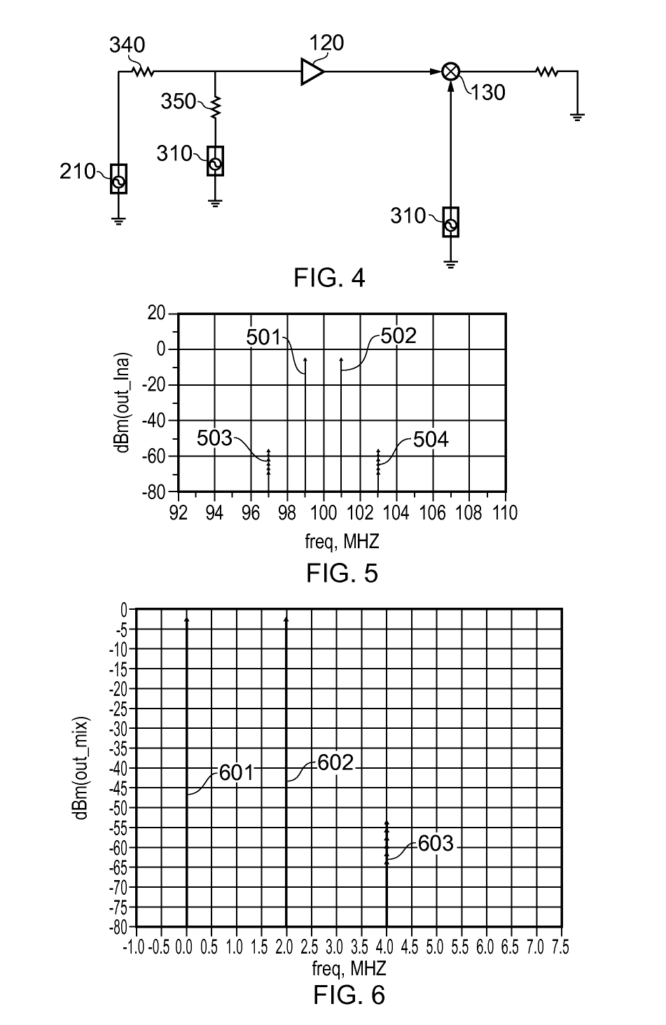

FIG. 4 schematically depicts a test bench of the test arrangement of FIG. 3. The test bench was designed using a commercially available design tool. In this test set-up, the signal source 210 is arranged to generate a RF signal at 101 MHz and the further signal source 310 is arranged to generate a further RF signal at 99 MHz. The signals are passed through respective resistors 440 and 450 for generating the tones f₁ and f₂. The respective resistors 440 and 450 each have a resistance of 6 kΩ. The tones f₁ and f₂ are fed to the input of the LNA 120. The module 130 is a mixer, which is provided with a LO frequency reference signal of 99 MHz from the further signal source 310.

FIG. 5 depicts the output signals of the LNA generated during various simulation runs with the test bench of FIG. 4, in which the power of the tones f₁ and f₂ was varied. Signal 501 is the resultant of input tone f₁ and signal 502 is the resultant of input tone f₁. Signals 503 and 504 are the third-order signals resulting from 2f₂−f₁ and 2f₁−f₂ respectively. As can be seen from the multiple arrow heads in the signals 503 and 504, the non-linearity in the gain of the LNA 120 depends on the strength of its input signal, as expected.

FIG. 6 depicts the output signals of the mixer 130, with the output signal 601 being the resultant of the output signal 501 generated by tone f₁ at the LO frequency of the mixer (99 MHz) and the output signal 602 being the resultant of the output signal 502 generated by tone f₂. The mixer output signal 603 is the IP3 level of the LNA 120, which can now be measured, e.g. using the signal processor 150. The multiple arrow heads in output signal 603 demonstrate the variation in IP3 as a function of the variation in LNA input signal strength.

Table I gives an overview of the simulation results using the test bench of FIG. 4.

TABLE I

| IP3 LNA | IP3 LNA | IP3 mixer |
|---|---|---|
| (dB) | output (dB) | output (dB) |
| −10.000 | −10.104 | −10.142 |
| −9.000 | −9.082 | −9.115 |
| −8.000 | −8.065 | −8.094 |
| −7.000 | −7.052 | −7.079 |
| −6.000 | −6.041 | −6.068 |
| −5.000 | −5.033 | −5.060 |

Table I shows the IP3 imposed on the LNA 120 by the simulator (left column), the IP3 measured at the LNA output (middle column) and the IP3 measured on the output of the mixer (right column). It is clearly demonstrated by the simulation that the test arrangement is capable of determining the IP3 of the LNA with high accuracy; the largest deviation between the imposed IP3 and the measured IP3 is well within the preferred accuracy window of ±0.5 dB. Hence, the on-chip IP3 test arrangement as shown in FIG. 3 facilitates an IP3 determination at a sufficient accuracy, thus obviating the need for expensive external test equipment. This makes this solution particularly attractive for testing devices that cannot be easily accessed, such as a system-in-package.

Moreover, the test arrangement of FIG. 3 is particularly suitable for use in an IC in which RF and base band systems co-exist such that the digital signal processor of the base band stage may be re-used for determining the IP3 of the LNA 120 in the RF signal processing stage. The test arrangement of FIG. 3 may also be used for calibrating the RF processing stage by accurate determination of the IP3.

In yet a further alternative embodiment of the present invention, the test arrangement as shown in FIG. 2 may be amended to facilitate the testing of an IC 100 arranged to operate in a number of different modes. The strengths of the respective RF signals processed in these different modes can vary significantly, which means that each of these operational modes must be tested separately to verify that the IC 100 operates within its allowable tolerances in each of these modes. Since the complementary transistor pair 230 typically provides a RF test signal of fixed strength due to the fact that this signal strength is the result of the rail-to-rail swing enforced on the transistor pair 230 by the sinusoidal signal generated by the signal source 210 (and the amplifying stage 220), a downstream solution is required to generate a RF test signal of which the signal strength can be accurately tuned.

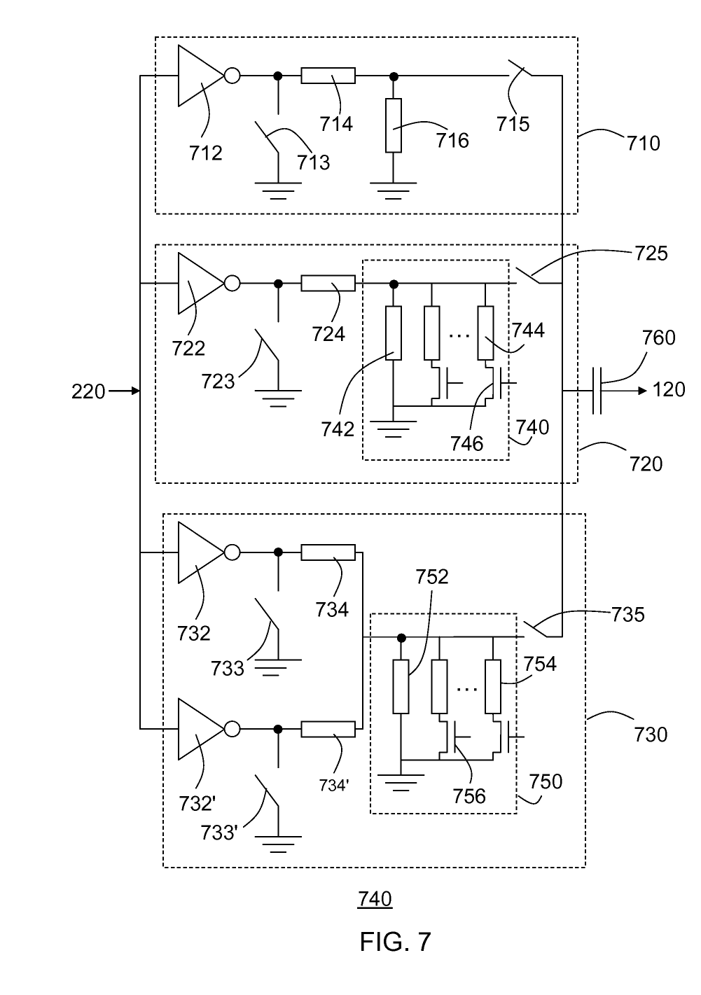

A possible solution is to replace the attenuator 240 in FIG. 2 with a programmable attenuator, i.e. an attenuator having a programmable attenuation factor. An embodiment of a programmable attenuator 700 is shown in FIG. 7. The programmable attenuator 700 comprises a first attenuation stage 710, a second attenuation stage 720 and a third attenuation stage 730 coupled in parallel between the complementary transistor pair 230 and the LNA 120. A coupling capacitance 760 may be provided to reduce the noise on the respective attenuated signals produced by these attenuation stages. The attenuation stages 710, 720 and 730 are coupled to the LNA 120 via respective selection switches 715, 725 and 735. During test, one of these selection switches is typically closed (i.e. in a conductive state), with the remaining selection switches being opened (i.e. in a non-conductive state).

The first attenuation stage 710 comprises a buffer 712, which may be inverting or non-inverting, coupled to a first resistor 714. A node between the buffer 712 and the first resistor 714 is coupled to a fixed potential source, e.g. VSS or ground, via an enable switch 713. Typically, when the selection switch 715 is opened, the enable switch 713 is closed to ensure that the first attenuation stage does not affect the input signal received from the complementary transistor pair 230. The first attenuation stage 710 further comprises a second resistor 716 coupled between a further node located between the first resistor 714 and the selection switch 715 and a fixed potential source, e.g. VSS or ground. The respective resistances 714 of the first resistor and the second resistor 716 determine the attenuation ratio A of the input signal (also referred to as attenuation factor):

$$A = \frac{{R}_{1}}{{R}_{0} + {R}_{1}} \qquad ( 2 )$$

wherein R₀ and R₁ are the resistances of the first resistor 712 and the second resistor 714 respectively, and wherein Pₒᵤₜ=A·Pₙ, with Pᵢₙ and Pₒᵤₜ being the strength of the input and output signals of the attenuator 700. R₀ and R₁ may be chosen to have any suitable value, as dictated by the design of the IC 100. The first attenuation stage 710 is used as a reference attenuation stage, as will be explained in more detail later.

The second attenuation stage 720 is a programmable attenuation stage and comprises a buffer 722, which may be inverting or non-inverting, coupled to a first resistor 724 having a resistance R₀ as per equation (2). A node between the buffer 722 and the first resistor 724 is coupled to a fixed potential source, e.g. VSS or ground, via an enable switch 723 for reasons already explained in the description of the first attenuation stage 710. The second attenuation stage 720 further comprises a programmable resistor 740 having a programmable resistance R₁ as per equation (2) coupled between a further node located between the first resistor 724 and the selection switch 725 and a fixed potential source, e.g. VSS or ground.

In FIG. 7, the programmable resistor comprises a resistor 742 permanently connected to the fixed potential source and M resistors 744 each coupled to the fixed potential source via respective further enable switches 746, wherein M is a positive integer. The resistor 742 may have the same or a different resistance than each of the resistors 744. The resistors 744 may have the same resistances or may have different resistances.

Because R₁ is programmable in this attenuation stage, the attenuation ratio A of this stage is programmable, as is evident from the above equation. The resistance R₁ may be programmed by the inclusion of any number of resistors 744 from 0 up to and including M resistors 744 in the second attenuation stage 720 by switching the corresponding further enable switches 746 to a conductive state.

The programmable resistor 740 may be any suitable programmable resistor. It is noted that a programmable resistor is known per se and many different embodiments of such a programmable resistor will be apparent to the skilled person. For instance, the resistor 742 may be omitted as long as it is ensured that at least one of the selectable resistors 744 is selected at all time during a test mode in which the second attenuation stage 720 is enabled.

In an embodiment, the resistance R₀ of the second attenuation stage 720 is chosen to be small compared to the programmable resistance R₁. Consequently, A is close to 1 such that the attenuation of the input signal is relatively small, and the attenuation steps by selecting a different number of selectable resistors 744 can also be kept small. Hence, the programmable attenuation stage 720 is particularly suitable for the generation of RF test signals of considerable signal strength. It will be apparent to the skilled person that the step size of the programmable resistor 740 is governed by the resistances of the selectable resistors 744.

In order to generate RF test signals having a relatively small signal strength, an additional programmable attenuation stage according to the design of the programmable attenuation stage 720 may be added in which R₀ and R₁ are chosen such that a different ratio between R₀ and R₁ is obtained for the purpose of achieving a smaller attenuation ratio A. This may be achieved by changing the resistance R₀ and/or by changing the programmable resistance R₁, e.g. by changing the number M, by changing the resistance of the permanently connected resistor 742, and so on.

The programmable second attenuator stage 720 may be seen to have an input stage formed by the buffer 722 and the resistor 724 and a shunt stage formed by the programmable resistor 740.

It is pointed out that the input stage does not have to be limited to a single buffer/resistor pair, as is demonstrated by third attenuation stage 730, which also is a programmable attenuation stage and comprises a first buffer 732, which may be inverting or non-inverting, coupled to a first resistor 734 having a resistance R₀ as per equation (2). A node between the first buffer 732 and the first resistor 734 is coupled to a fixed potential source, e.g. VSS or ground, via an enable switch 733 for reasons already explained in the description of the first attenuation stage 710.

In addition, the third attenuation stage 730 comprises a further buffer 732, which may be inverting or non-inverting, coupled to a further resistor 734′ having a resistance R₀, which is typically different to R₀ of the first resistor 732. A node between the further buffer 732′ and the further resistor 734′ is coupled to a fixed potential source, e.g. VSS or ground, via an enable switch 733′. Hence, the third attenuation stage comprises two input stages having a different resistance such that different attenuation factors may be achieved by selecting different input stages. The appropriate input stage may be selected by disconnecting the enable switch coupled to the node between the buffer and resistor of the input stage from the fixed potential source. The third attenuation stage 730 has two parallel input stages by way of non-limiting example only. Any suitable number of input stages may be chosen.

The third attenuation stage 730 further comprises a programmable resistor 750 having a programmable resistance R₁ as per equation (2) coupled between a further node located between the first resistor 734 and the selection switch 735 and a fixed potential source, e.g. VSS or ground. The programmable resistor 750 may comprise a resistor 752 permanently connected to the fixed potential source and N resistors 754 each coupled to the fixed potential source via respective further enable switches 756, wherein N is a positive integer. The resistor 752 may have the same or a different resistance than each of the resistors 754. The resistors 754 may each have the same resistances or may have different resistances. The number N may be the same as or may be different to the number M.

In an embodiment, the resistances R₀ and R₁ of the third attenuation stage are chosen such that the attenuation of the input signal is larger than can be realized by the second attenuation stage 720. Hence, the programmable third attenuation stage 730 is particularly suitable for the generation of RF test signals of limited signal strength. By switching from R₀ to R₀′, the attenuation ratio of the third attenuation stage 730 may be further modified.

For the sake of completeness, it is pointed out that the use of the same resistance label, i.e. R₀ and R₁, for the various resistors of the various attenuation stages of the programmable attenuator 700 is for the purpose of linking these resistances to equation (2) only and is not intended to imply that resistors in different attenuation stages sharing the same label have the same resistance. For instance, the value R₀ of resistor 714 may be different to the value R₀ of resistor 724, and so on.

The various test configuration switches such as the selection switches 715, 725 and 735, the enable switches 713, 723, 733 and 733′ and the further enable switches 746 and 756 may be controlled in any suitable manner. For instance, the signal processor of the IC, e.g. the signal processor 150 shown in FIG. 3, may generate control signals for controlling these switches. To this end, the signal processor may for instance implement a state machine stepping through the predefined test steps for testing the receiver of the IC 100. This would constitute a complete BIST solution. Alternatively, the test configuration switches may be controlled by means of a shift register (not shown), with the respective bits shifted into the shift register controlling respective test configuration switches. Such a shift register may for instance be a part of a boundary scan-compliant test access port (TAP). Such a TAP is sometimes referred to as a JTAG TAP.

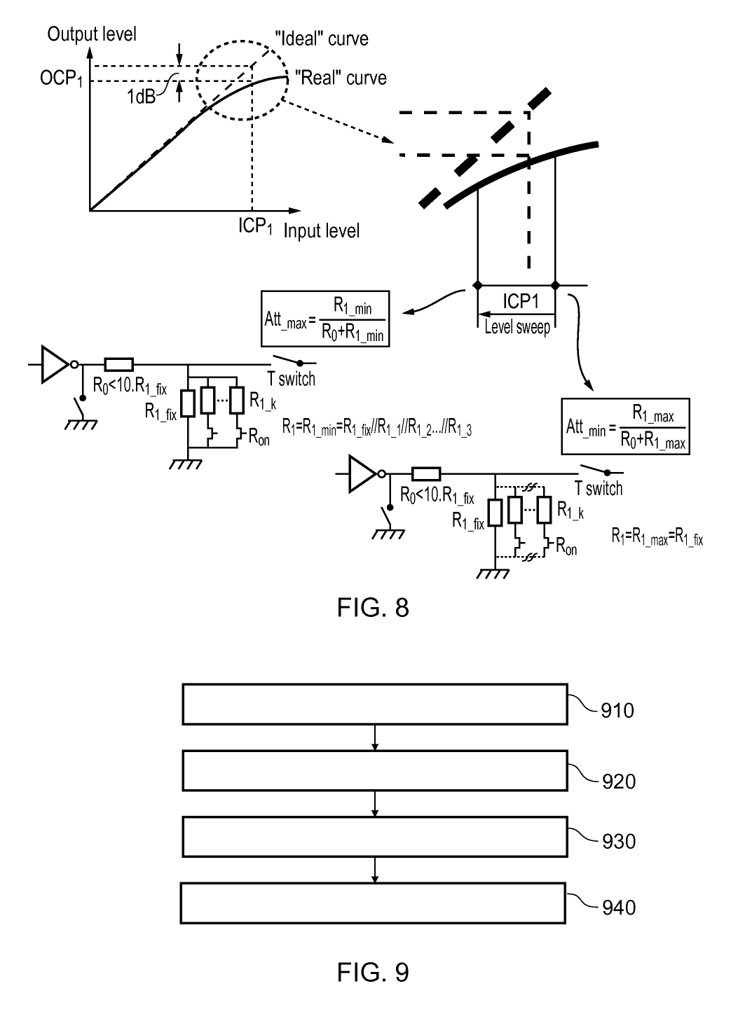

FIG. 8 depicts the effective attenuation of an input signal from the complementary transistor pair 230 by the programmable attenuator 730, as determined by a CP1 measurement. As can be seen from FIG. 8, at large attenuation, the effective attenuation (solid line) can start to deviate from the expected attenuation factor (dashed line). This is caused by the fact that a programmable resistor, e.g. programmable resistor 740, comprises a relatively large number of switches, which may be sensitive to process variation and mismatch. For attenuation stages comprising only a few of such switches, e.g. the first attenuation stage 710, it has been found that this deviation is well within acceptable tolerances, i.e. well within 0.5 dB. However, for the programmable attenuation stages, this deviation may exceed these acceptable tolerances.

In order to ensure that a test result of the receiver stage of the IC 100 has the required accuracy, the programmable attenuator 700 may be calibrated prior to testing the receiver stage. A flow chart of an embodiment of such a calibration method is depicted in FIG. 9.

The calibration method is based on the aforementioned realization that the first attenuation stage 710 exhibits an effective attenuation factor well within acceptable tolerances. To this end, the first attenuation stage 710 is used as a reference stage for the calibration of one or more of the programmable attenuation stages of the programmable attenuator 700. In step 910, the reference attenuation stage 710 is selected and provided with an input signal from the complementary transistor pair 230. The gain factor of the LNA 120 is subsequently determined based on the output signal generated by the LNA 120 in response the input signal as attenuated by the reference attenuation stage 710.

In a next step 920, the programmable attenuation stage to be calibrated, e.g. the second attenuation stage 720, is selected and programmed to match the attenuation factor of the reference attenuation stage 710. The input signal from the complementary transistor pair 230 is subsequently attenuated and the resulting gain factor of the LNA 120 is determined.

In step 930, the gain factor determined in step 910 is compared to the gain factor determined in step 920. This may for instance be done as shown in equation (3), where G₉₁₀ is the gain factor determined in step 910, G₉₂₀ is the gain factor determined in step 920 and R is the ratio between these gain factors.

$$R = \frac{{G}_{910}}{{G}_{920}} \qquad ( 3 )$$

Because the programmable attenuation stage was programmed to match the attenuation factor of the reference attenuation stage 710 and the input signals used in steps 910 and 920 were identical, these two gain factors should be identical within an acceptable tolerance window, i.e. R=1. If this is not the case, i.e. R≠1, it has been determined that the accuracy of the attenuation of the programmable attenuation stage is not sufficient.

The method then proceeds to step 940 in which a gain correction factor for this programmable attenuation stage is defined. Typically, this correction factor will be 1/R and will be applied to any gain factor determined by using the corresponding programmable attenuation stage such that the determined gain factor is compensated for the process variations and mismatches in the test configuration switches of the corresponding programmable attenuation stage. The above method is particularly suitable for calibrating programmable attenuators realized in sub-micron CMOS technologies because the transistors in these technologies are particularly prone to exhibit substantial process spread and mismatch.

The above method may be repeated for each programmable attenuation stage of the programmable attenuator 700 such that a gain correction factor is obtained for each of the programmable attenuation stages, e.g. stages 720 and 730 in FIG. 7. It will be appreciated that the programmable 700 of FIG. 7 comprises a single reference stage 710 by way of non-limiting example only. It may be advantageous to have a plurality of reference stages with different attenuation factors, for instance when the programmable attenuator comprises multiple programmable attenuation stages for generating attenuated signals with different signal strengths, for which it may be possible that a programmable attenuation stage for generating a relatively weak RF signal cannot match the attenuation factor of a reference stage for providing a reference attenuation signal for another programmable attenuation stage for generating a relatively strong RF signal.

At this point, it is emphasized that the attenuators 340 and 350 as shown in FIG. 3 may also be replaced with respective programmable attenuators 700. This has the advantage that the IP3 of the LNA 120 may be tested at various signal strengths, which for instance may provide valuable information about the signal strength at which the LNA 120 starts exhibiting non-linear behavior above a predefined threshold, e.g. 1 dB.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage

1. An integrated circuit comprising:
a test arrangement for generating a radio-frequency test signal, the test arrangement comprising:
a signal source for generating a radio-frequency control signal; and
a complementary transistor pair, the transistors of said pair being coupled in series between a first supply rail and a second supply rail, and being arranged to generate the radio-frequency test signal on its output in response to the radio-frequency control signal supplied to its control terminals.

2. An integrated circuit as claimed in claim 1, further comprising:
a module for processing a radio-frequency signal during normal operation of the integrated circuit; wherein:
the test arrangement is arranged to provide said module with the radio-frequency test signal in a test mode of the integrated circuit.

3. The integrated circuit of claim 2, further comprising an attenuator coupled, in the test mode, between the output of the transistor pair and an input of the module.

4. The integrated circuit of claim 3, further comprising:
a further signal source for generating a further radio-frequency control signal having a different frequency than the radio-frequency signal;
a further complementary transistor pair, the transistors of said pair being coupled in series between the first supply rail and the second supply rail, and being arranged to generate the further radio-frequency test signal on its output in response to the further radio-frequency control signal supplied to its control terminals; and
a further attenuator coupled between the further transistor pair and the input of the module.

5. The integrated circuit of claim 4, wherein the attenuator is coupled to the input of the module via a first resistor and the further attenuator is coupled to the input of the module via a further resistor.

6. The integrated circuit of claim 3, wherein the attenuator comprises a plurality of branches coupled in parallel between the complementary transistor pair and the module, wherein each branch comprises a selection switch for selecting said branch in the test mode, and wherein the plurality of branches comprise:
a first branch comprising a first resistor coupled between the complementary transistor pair and a first node and a second resistor coupled between a fixed potential source and the first node for providing a fixed attenuation factor; and
at least one further branch comprising a first further resistor coupled between the complementary transistor pair and a second node and a programmable resistor coupled between a fixed potential source and the second node for providing a programmable attenuation factor.

7. The integrated circuit of claim 6, wherein a further branch comprises a second further resistor coupled in parallel with the first further transistor.

8. The integrated circuit of claim 7, wherein the at least one further branch comprises a first further branch having a single further resistor coupled between the complementary transistor pair and the second node of said branch, and a second further branch having a first further resistor coupled in parallel with a second further resistor between the complementary transistor pair and the second node of said branch.

9. The integrated circuit of claim 8, wherein a resistor coupled between the complementary transistor pair and one of said nodes is coupled to the complementary transistor pair via a further node, the further node being coupled to a fixed potential source via an enable switch.

10. The integrated circuit of claim 7, wherein the programmable resistor comprises a plurality of resistors coupled in parallel, each resistor of said plurality of resistors being coupled to a respective further enable switch.

11. The integrated circuit of claim 7, wherein the test arrangement further comprises a shift register arranged to provide test configuration data for configuring the respective selection switches, the respective enable switches and/or the respective programmable resistors.

12. The integrated circuit of claim 7, further comprising a signal processor coupled to the module, the signal processor being arranged to:
select the first branch;
perform a first gain measurement;
select one of the at least one further branch;
program the programmable resistor of selected further branch such that the selected further branch is intended to have the same attenuation factor as the first branch;
perform a second gain measurement;
calculate a correction factor from a difference between the first gain measurement and the second gain measurement; and
correct a subsequent gain measurement using the selected further branch with the correction factor.

13. The integrated circuit of claim 2, further comprising an amplifying stage between the signal source and the transistor pair.

14. The integrated circuit of claim 13, wherein the amplifying stage comprises an inverter chain of at least two inverters.

15. The integrated circuit of claim 3, further comprising a further amplifying stage having an input coupled to the attenuator output and an output coupled to the module, said further amplifying stage input being arranged to receive the radio frequency signal from an input of the integrated circuit.

16. The integrated circuit of claim 15, further comprising a resistor coupled between the attenuator and the further amplifying stage.

17. The integrated circuit of claim 2, further comprising a signal evaluator coupled to an output of the module, the signal evaluator being arranged to evaluate a response of the module to the radio-frequency test signal.

18. The integrated circuit of claim 2, further comprising a processing unit for switching between the normal operation and the test mode.

19. An electronic device arranged to receive and/or transmit radio-frequency signals, the electronic device comprising an integrated circuit as claimed in claim 2.

20. A method of testing a module of an integrated circuit, said module being arranged to process a radio-frequency signal during normal operation of the integrated circuit, the method comprising:
providing the integrated circuit with a test arrangement for generating a radio-frequency test signal for testing the module in a test mode, the test arrangement comprising a signal source for generating a radio-frequency control signal in the test mode; a complementary transistor pair, the transistors of said pair being coupled in series between a first supply rail and a second supply rail, and being arranged to generate the radio-frequency test signal on its output in response to the radio-frequency control signal supplied to its control terminals;
generating a radio-frequency control signal with the signal source; and
providing the first supply rail with a stable supply voltage such that the transistor pair produces the radio-frequency test signal within acceptable noise levels in response to the radio-frequency control signal.

21. A method as claimed in claim 21, wherein the test arrangement further comprises an attenuator coupled, in the test mode, between the output of the complementary transistor pair and an input of the module, the attenuator comprising a plurality of branches coupled in parallel between the complementary transistor pair and the module, wherein each branch comprises a selection switch for selecting said branch in the test mode, and wherein the plurality of branches comprise:
a first branch comprising a first resistor coupled between the complementary transistor pair and a first node and a second resistor coupled between a fixed potential source and the first node for providing a fixed attenuation factor; and
at least one further branch comprising a first further resistor coupled between the complementary transistor pair and a second node and a programmable resistor coupled between a fixed potential source and the second node for providing a programmable attenuation factor;
wherein the method further comprises:
selecting the first branch;
performing a first gain measurement;
selecting one of the at least one further branch;
programming the programmable resistor of selected further branch such that the selected further branch is intended to have the same attenuation factor as the first branch;
performing a second gain measurement;
calculating a correction factor from a difference between the first gain measurement and the second gain measurement; and
correcting a subsequent gain measurement using the selected further branch with the correction factor.
